(19) United States
(12) Patent Application Publication
(10) Pub. No.: US 2002/0109762 A1
(43) Pub. Date: Aug. 15, 2002

(54) INK JET RECORDING APPARATUS

(76) Inventors: MINORU USUI, NAGANO (JP); NORIAKI OKAZAWA, NAGANO (JP); SATORU HOSONO, NAGANO (JP); TOMOAKI TAKAHASHI, NAGANO (JP)

Correspondence Address: SUGHRUE MION ZINN MACPEAK & SEAS, 2100 PENNSYLVANIA AVENUE NW, WASHINGTON, DC, 200373202

(21) Appl. No.: 09/242,490

(22) PCT Filed: Jun. 29, 1998
(86) PCT No.: PCT/JP98/02898

(30) Foreign Application Priority Data
Jul. 2, 1997 (JP) P.HEI 9-191918
Feb. 16, 1998 (JP) P.HEI10-50101

(51) Int. Cl. B41J 2/175

(52) U.S. Cl. 347/93

(57) ABSTRACT

Grooves 21 are formed in the side of an ink supply needle 17 opposite a filter 19 in order to induce the movement of ink using capillary attraction, and so that the grooves 21 ensure that ink can flow along a path to a recording head regardless of whether an air bubble is present.

### FIELD OF THE INVENTION

The present invention relates to an ink-jet recording apparatus that includes a recording head for ejecting ink droplets through nozzle openings in response to a print signal, and an ink cartridge used to supply ink to the recording head.

### BACKGROUND OF THE INVENTION

An ink-jet recording apparatus, which includes a recording head and an ink cartridge used to supply ink to the recording head, is so designed that a supply port is formed in the ink cartridge and that, to supplement the supply of ink, the ink cartridge is inserted into or removed from an ink supply needle that communicates with the recording head.

As is shown in FIG. 13, an ink supply needle A is so designed that a filter chamber D is formed by opening a joint area using an ink supply path C that communicates with a recording head B, and that air bubbles, which are generated or have grown in an ink cartridge, or dust, are captured at the filter E and are prevented from flowing into the recording head B.

However, for a recording head for which light colored inks are employed to improve the color print quality, the space around the recording head must be relatively narrow in order for at least six colored inks to be supplied to the recording head, and accordingly, the diameter of the ink needle A must be reduced. As a result, an air bubble F is formed that remains stagnant inside the ink supply needle A and interrupts the supply of ink to the recording head B.

In addition, when a recording head having multiple nozzle openings is employed to increase the recording density and the print quality, the dimensions of the filter E must be increased and the flow path resistance must be reduced in order to smoothly supply a large volume of ink to the recording head. Accordingly, a large space is produced upstream of the filter member, so that the flow rate of ink is reduced there and air bubbles are not discharged. These air bubbles stick to the filter member and increase the flow path resistance. And as a result, they interrupt the supply of ink to the recording head.

Further, when a large air bubble B enters the filter chamber D during the ink loading process, the air bubble adversely affects the flow of ink, and the difference in the pressures between the upstream and the downstream sides of the filter E is increased.

In particular, for a recording head in which ink carried by a single supply needle branches off to a plurality of ink supply paths C and supplies ink to a plurality of nozzle openings, if the internal face of the filter chamber D is not kept uniformly wet, ink will flow across a wetter portion, and will form an ink flow induction path. Then, when the induction path is so positioned that it can easily communicate with the ink supply path C, if ink flows to the ink supply path C before the filter chamber D is completely filled, the air bubble F will remain in the filter chamber D, regardless of the attraction exerted by the ink, and will be difficult to discharge.

### DISCLOSURE OF THE INVENTION

An ink-jet recording apparatus according to the present invention comprises:

a recording head for receiving ink supplied via a first ink supply path and for ejecting ink droplets;

a second ink supply path along which ink is transmitted from an ink cartridge to the first ink supply path; and

a filter which is located at a joint area that forms a communication portion situated between the first ink supply path and the second ink supply path,

wherein ink induction paths are formed at the joint area on the side of the second ink supply path in order to use capillary attraction to induce the flow of ink through the filter.

It is, therefore, one objective of the present invention to provide an ink-jet recording head, wherein the flow of ink to a recording head is not disturbed by air bubbles that are generated during the loading of ink, and wherein ink can be supplied to the recording head while at the same time air bubbles are removed.

### BRIEF DESCRIPTION OF THE DRAWINGS

FIG. 1 is a diagram illustrating an ink-jet recording apparatus according to one embodiment of the present invention;

FIG. 2 is a cross-sectional view of the connection of the ink cartridge and the recording head of the ink-jet recording apparatus;

FIG. 3 is an enlarged cross-sectional view of the area at the filter chamber in the recording head of the ink-jet recording apparatus;

FIG. 4 is an enlarged bottom view of the second ink supply path of the ink-jet recording apparatus;

FIGS. 5(a) to 5(e) are diagrams showing the movement of an air bubble in the filter chamber during printing performed by the ink-jet recording apparatus;

FIG. 6 is a diagram illustrating another example recording head used for the ink-jet recording apparatus of the present invention;

FIGS. 7(a) to 7(c) are a bottom view of an example ink supply needle for the ink-jet recording apparatus and cross-sectional views taken along lines A-A and B-B;

FIGS. 8(I) to 8(III) are diagrams showing the flow of ink in the filter chamber of the ink-jet recording apparatus during the loading of ink;

FIGS. 9(a) to 9(c) are a bottom view of another example ink supply needle and cross-sectional views taken along lines A-A and B-B;

FIGS. 10(a) to 10(d) are cross-sectional views of an additional example ink supply needle;

FIGS. 11(a) and 11(b) are a cross-sectional view and a perspective view of another embodiment of the present invention;

FIGS. 12(a) and 12(b) are cross-sectional views of an additional embodiment of the present invention; and

FIG. 13 is a diagram of a conventional ink supply needle for explaining a phenomenon which occurs when the supply of ink to a recording head is deteriorated due to an air bubble.

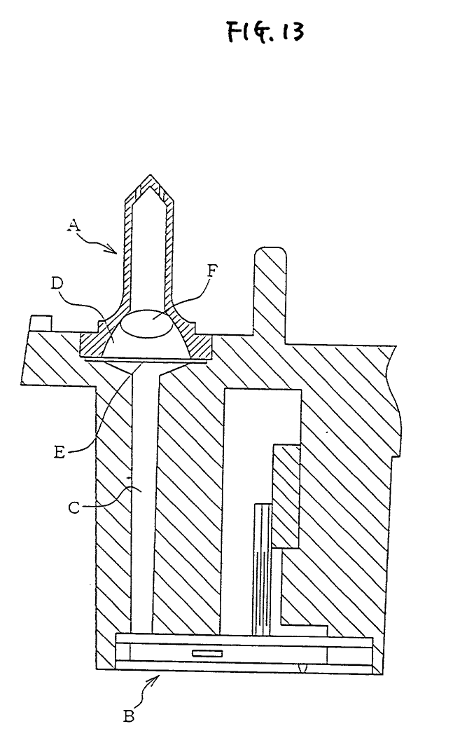

### DETAILED DESCRIPTION OF THE PREFERRED EMBODIMENTS

The embodiments of the present invention will now be described in detail while referring to the drawings.

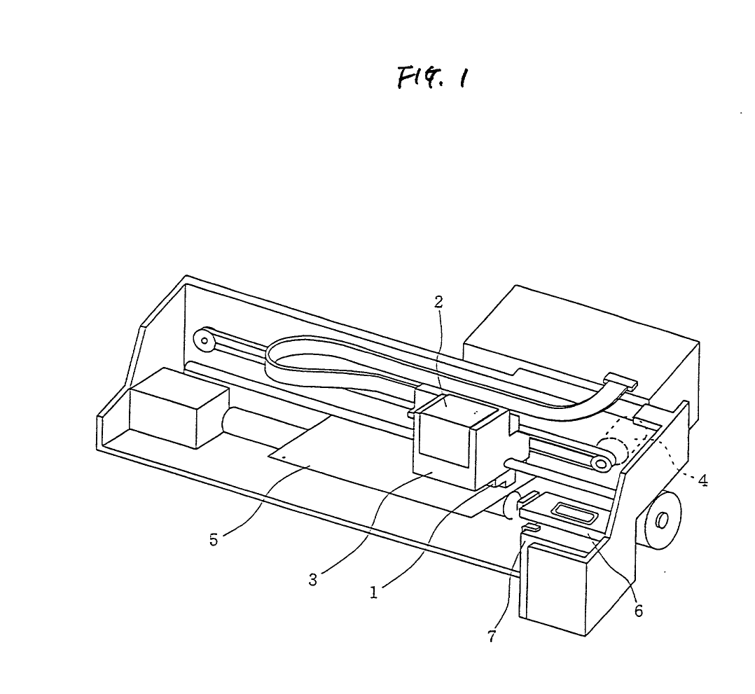

In FIG. 1 is shown an ink-jet recording apparatus according to one embodiment of the present invention. A recording head 1 for ejecting ink droplets upon receiving a print signal is mounted on a carriage 3 with an ink cartridge 2. The recording head 1 is moved along the width of a recording sheet 5 by a carriage drive motor 4, and ejects ink droplets through nozzle openings. Further, the recording head 1 receives a volume of ink, equivalent to the volume used for printing, from the ink cartridge 2 along an ink flow path that will be described later.

A capping unit 6, which is provided in a non-printing area, seals the recording head 1 to prevent the nozzle openings from drying out, and negative pressure produced by a suction pump 7 is applied in order to remove clogging at the nozzle openings, or to load ink in a replacement ink cartridge 2. A cleaning member 7 is also provided.

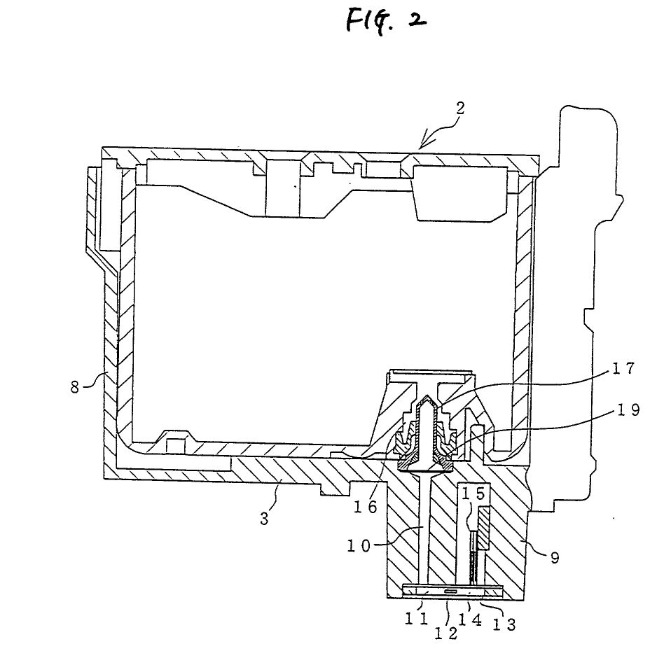

In FIG. 2 is shown an example arrangement for the recording head 1 and the ink cartridge. A cartridge holder 8 is located on the top of the carriage 3, while a head holder 9 is fixed to the bottom in order to secure the recording head 1.

The recording head 1 comprises: a reservoir 11, to which ink is supplied via a first ink supply path 110 that is provided by forming a through hole in the head holder 9; a pressure generating chamber 14, to which ink is supplied from the reservoir 11 via the ink supply port 12 for the ejection of ink droplets through a nozzle opening 13; and pressure means 15 for pressurizing the pressure generating chamber 14.

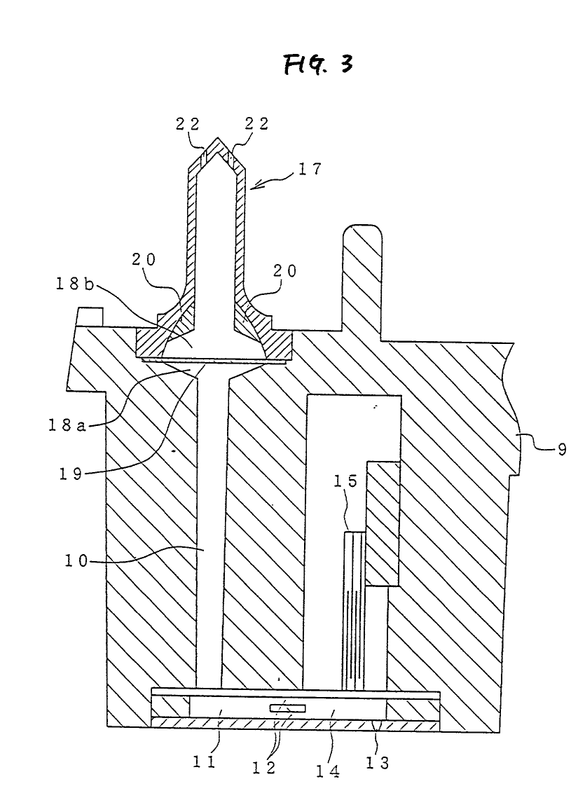

As is shown in FIG. 3, an ink supply needle 17 is provided upright on the face of the carriage opposite the ink cartridge, and serves as a second ink supply path that communicates with an ink supply port 16 of the ink cartridge 2.

Filter chambers 18a and 18b are defined at a joint area in the first ink supply path 10 and the ink supply needle 17, so that a boundary is set in the direction of the opening. A filter 19 extends across the joint area to remove air bubbles and dust from the ink.

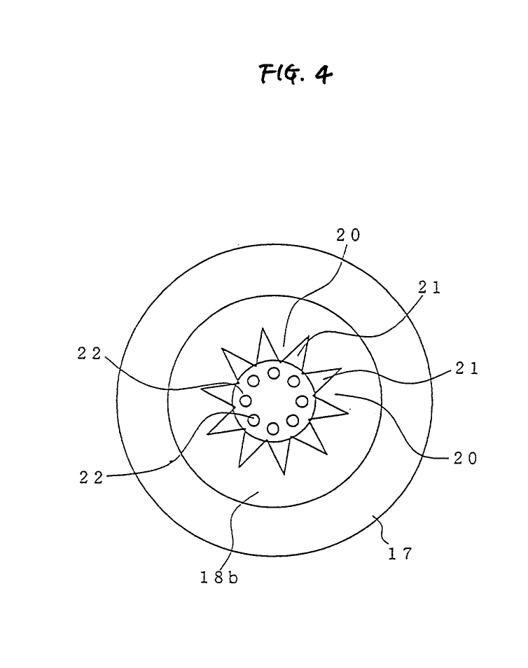

A plurality of projections 20, the distal ends of which extend inward toward the center, as is shown in FIG. 4, are radially located at pitches at which grooves 21, along which the movement of ink can be induced using capillary attraction, can be formed. Reference numeral 22 denotes ink induction holes through which ink is drawn from the ink cartridge 2 to the ink supply needle 17.

In this embodiment, the ink supply port 16 of the ink cartridge 2 is inserted into the ink supply needle 17, and the recording head 1 is sealed by the capping unit 6 to apply the negative pressure provided by the suction pump 6. Then, ink from the ink cartridge 2 flows through the ink induction holes 22 and the filter chambers 18b and 18a to the recording head 1, and air bubbles that become stagnant along the flow path that extends from the ink cartridge 2 to the nozzle opening 13 are discharged to the outside with ink.

When the ink filling job following the exchange of the ink cartridge is completed in this manner, and a drive signal is transmitted to the recording head 1, ink droplets are ejected from the recording head 1. As the pressure on the recording head side is reduced due to the ejection of the ink droplets, ink from the ink cartridge 2 flows into the recording head 1 in a volume equivalent to that used for the printing.

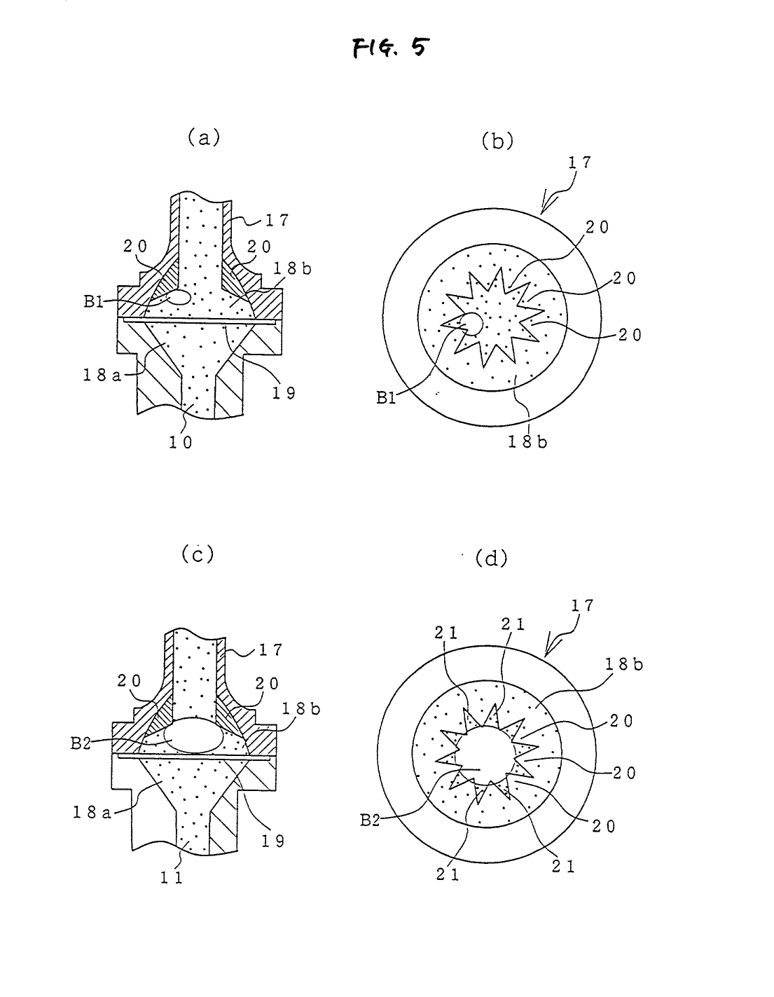

On the other hand, as is shown in FIGS. 5(a) and 5(b), when an air bubble B1 produced in the ink cartridge enters the ink supply needle 17 at the time the ink cartridge is mounted, or during printing, as the air bubble B1 can not pass through the filter 19, it stagnates in the upper filter chamber 18b and sticks to the projections 20.

When the air bubble B1 that is captured by the projections 20 has grown into a large air bubble B2, it is held by the distal ends 20a of the projections 20, as is shown in FIGS. 5(c) and 5(d). Since even in this state a plurality of grooves 21 that are formed between the projections 20 are still filled with ink, capillary attraction at the grooves 21 causes the ink to flow to the filter chambers 18b and 18a. Therefore, the volume of ink that is required for printing can be supplied to the recording head, and printing can be continued, regardless of whether stagnation of air bubbles occurs.

When clogging occurs in the recording head 1 because printing has been continued for an extended period of time, the recording head 1 is sealed by the capping unit 6 and negative pressure is applied to the entire flow path. Then, ink in the ink cartridge 2 quickly flows through the ink induction hole 22 to the filter chambers 18b and 18a. The fast ink flow draws, to the filter 19, the air bubble B2 that has been captured by the projections 20, and the bubble B2 is reduced to small pieces that in turn are drawn to the recording head and discharged to the capping unit 6 through the nozzle openings 13.

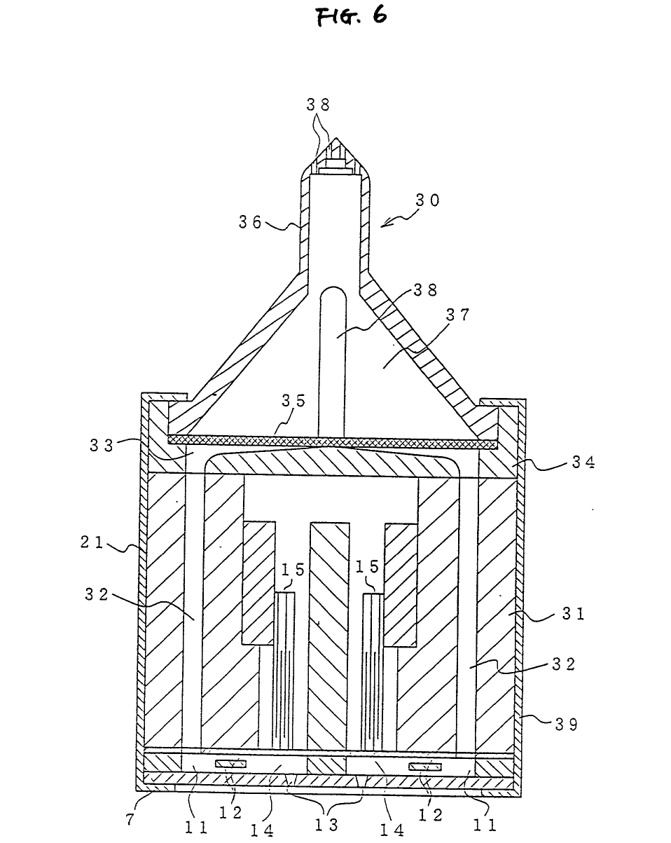

In FIG. 6 is shown another embodiment of the present invention, wherein ink is supplied through a single ink supply needle 30 to a plurality of first ink supply paths 32 in a head holder 31.

A filter chamber formation member 34 is fixed to the top of the head holder 31, and communicates with the ink inlets for the first ink supply paths 32 and forms a recessed portion that serves as a filter chamber 33. A filter 35 is disposed horizontally across the filter chamber 33, and the ink supply needle 30 is mounted on the filter 35 to form the second ink supply path.

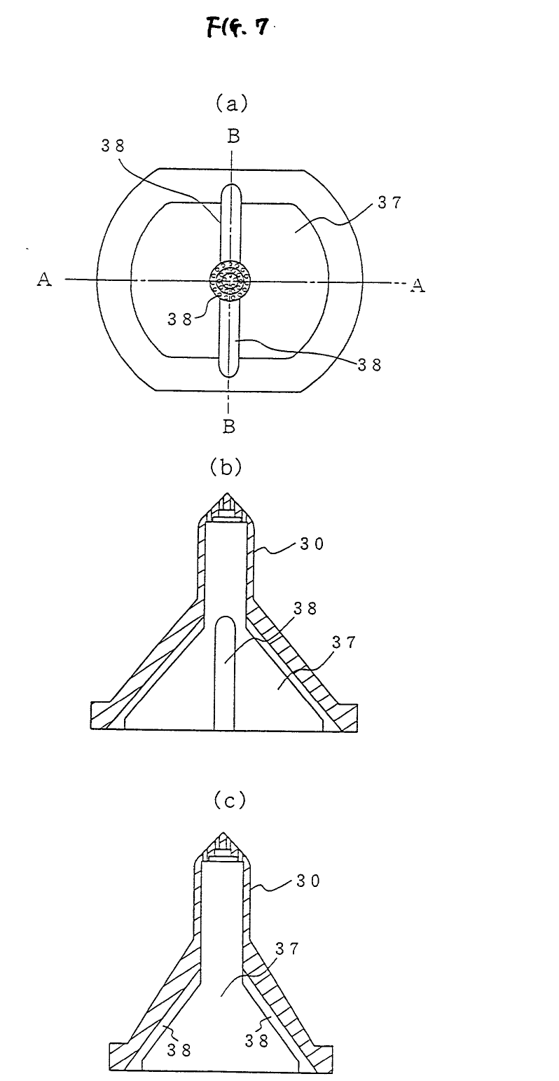

The ink supply needle 30 is constituted by an insertion portion 36 that has a needle-shaped tip, and a funnel-shaped filter chamber 37 below that is opened up to cover the two second ink supply paths 32. As is shown in FIG. 7, grooves 38 are formed in the internal face of the filter chamber 37 and are extended from the vicinity of the lower end of the insertion portion 36 to positions that are distant from the ink supply paths 32, preferably, in this embodiment, the middle portion of the area whereat the two ink supply paths 32 face each other, i.e., the positions that are farthest from the ink supply paths 32. Reference numeral 38 denotes an ink induction hole; and 39, a fixed frame.

In this embodiment, before being used, the ink cartridge 2 is mounted, the recording head 1 is sealed by the capping unit 2, and the suction pump 7 is driven to apply negative pressure to the recording head 1 and thereby initiate the loading of ink.

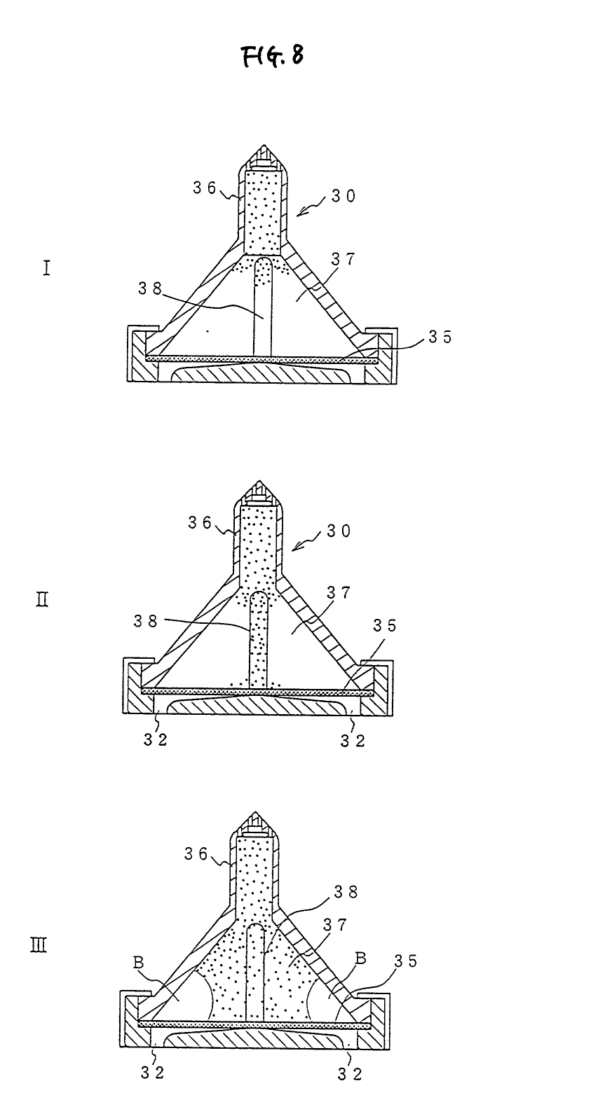

This negative pressure is applied to the ink supply needle 16 via the nozzle opening 13, the pressure generation chamber 14, the ink supply port 12, the reservoir 11 and the first ink supply path 32, and ink in the ink cartridge 2 is drawn into the insertion portion 36 of the ink supply needle 30. The ink, which has entered from the insertion portion 36, is attracted along the grooves 38 that are positioned below the insertion portions 36 by capillary attraction (FIG. 8(I)). While ink is wetting the grooves 38 and their peripheral area, the ink reaches the filter 35 and first wets one part of the area that is farthest from the second ink supply paths 32 (FIG. 8(II)). When the attraction of the ink is continued and the negative pressure applied to the entire flow path is increased, there is a rapid, large flow of ink into the filter chamber 37 along the grooves 38 that serve as induction paths. The ink drives the air in the filter chamber 37, or the air bubble B, toward the ink supply path, and gradually expands the area it occupies (FIG. 8(III)).

Since the negative pressure produced by the suction pump 7 is applied to the second ink supply paths 32, the air, or the air bubble B, that is driven out of the filter chamber 37 is induced to move along the second ink supply path 32 and is discharged from the nozzle openings 13 in the recording head 1 to the capping unit 6.

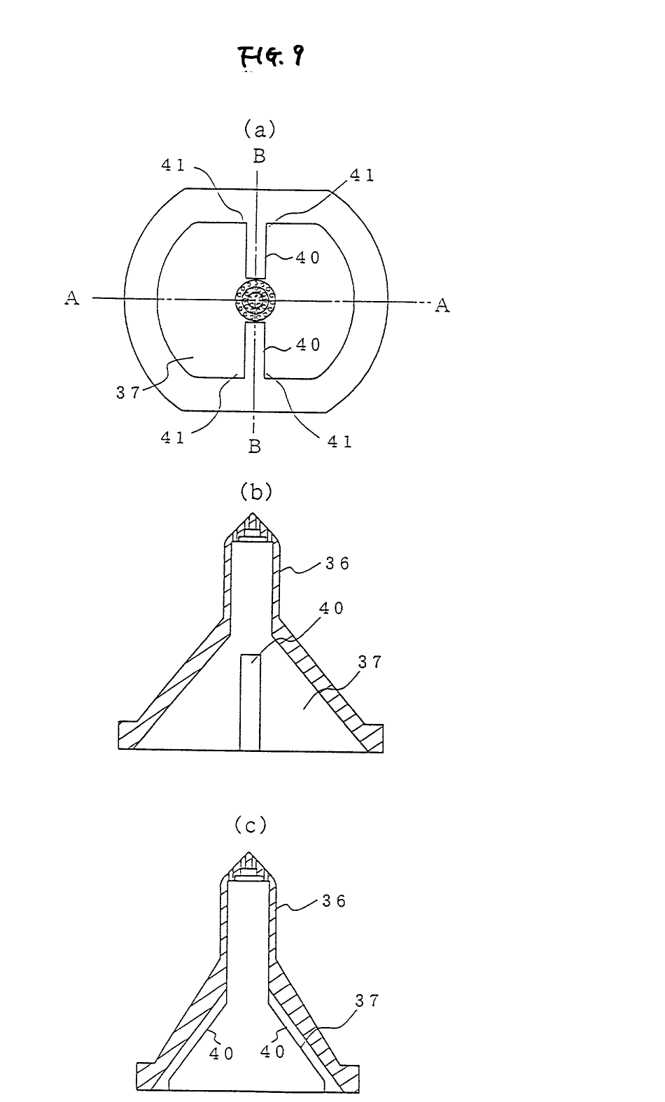

In FIG. 9 is shown an additional embodiment of the present invention, where ribs 40 are extended from the vicinity of the lower end of the insertion portion 36 to the area that is distant from the ink supply paths 32, preferably, the middle position located between the ink supply paths 32.

In this embodiment, capillary attraction at gaps 41 that are defined by the sides of the ribs 40 and the internal face of a filter chamber 38 is applied to the ink. Therefore, when the ink is initially loaded, it is induced to move along both faces of the ribs 40 to the area that is distant from the ink supply paths 32, and air is driven out of the isolated area through the ink supply paths 32 and is discharged from the filter chamber 37.

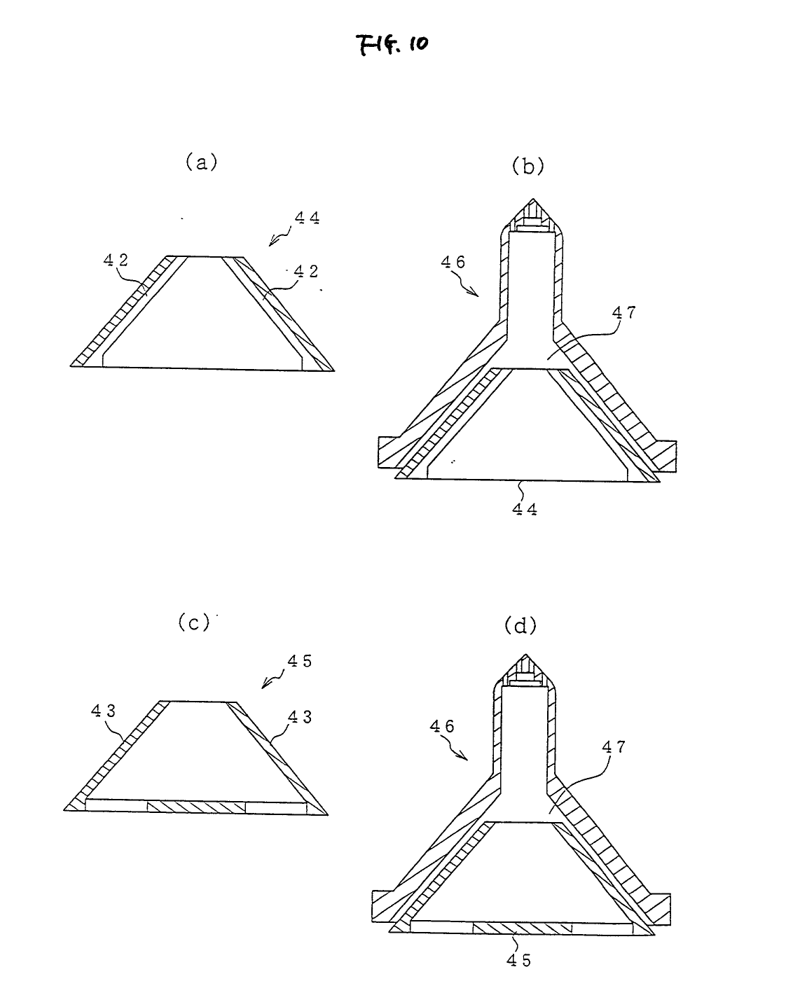

In the above embodiments, the grooves 38 or the ribs 40 are integrally formed with the filter chamber 37 of the ink supply needle 30. However, apparently the same effects can be produced when, as is shown in FIG. 10(b) or 10(d), a member 44 or 45 in which grooves 42 or ribs 43 are formed, as is shown in FIG. 10(a) or 10(c), is mounted in a filter chamber 47 of an ink supply needle 46.

According to the above embodiments, the speed at which ink is loaded can be improved, and the removal of air bubbles can be facilitated, without the mold for the manufacture of the ink supply needle being changed.

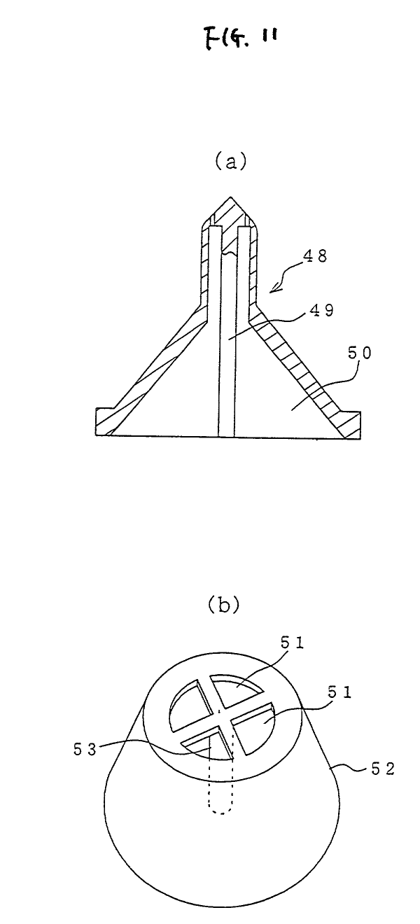

In addition, in the above embodiments, the ink induction paths are formed so that they are positioned around the circumferential face of the filter chamber. However, the same effect can also be obtained when, as is shown in FIG. 11(a) or 11(b), an induction member 49 that extends inward to the center of a filter 35 is coaxially formed with an ink supply needle 48.

Specifically, in the example in FIG. 11(a) the induction member 49 is integrally formed with the ink supply needle 48, and in the example in FIG. 11(b) a rod-shaped induction member 53 is formed along the center line of a member 52 that can be mounted in a filter chamber 50 and that has ink flow windows 51. The lengths of the induction members 49 and 53 are so adjusted that their lower ends substantially contact the filter 35 in order to spread the ink out across the surface of the filter 35.

According to these examples, the ink that has entered the ink supply needle 48 is guided to the surface of the induction member 49 or 53 and wets the center portion of the filter 35 first that distant from the ink supply paths 32. Therefore, as well as in the previous embodiments, the ink can be loaded while air bubbles are removed.

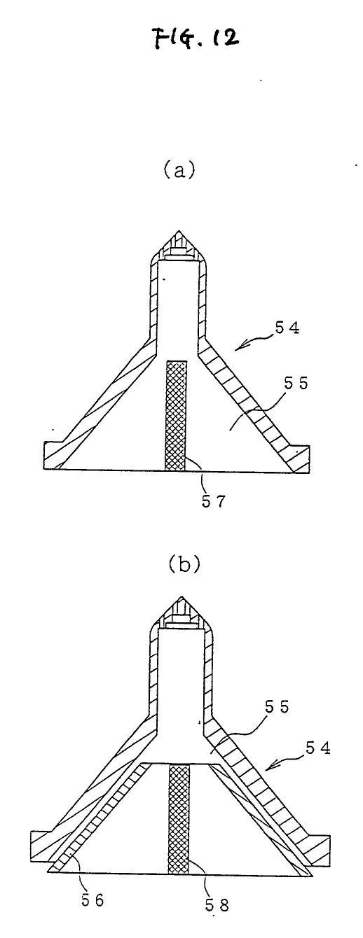

Furthermore, according to the embodiments, the movement of ink is induced by capillary attraction that is exerted at the gaps between the grooves or the ribs, and the internal faces whereat they are formed. However, the same effect can also be obtained when a belt-shaped layer 57 or 58 of medicine that has an affinity to ink is formed vertically on the inner circumferential face of a filter chamber 55 of an ink supply needle 54 as is shown in FIG. 12(a), or vertically on the inner circumferential face of a member 56 that is located in the filter chamber as is shown in FIG. 12(b).

In the above embodiments, an explanation has been given for a case where two ink induction paths are formed. It is, however, apparent that the same effect can be acquired with one ink induction path or with three or more induction paths. Further, in the above embodiments, a recording head is employed wherein the ink supply paths are constituted by through holes that are formed in the head holder. However, apparently the same effect can be obtained when the present invention is applied to a recording head where ink supply paths are formed in different members, such as tubes.

### INDUSTRIOUS USABILITY

As is described above, according to the present invention, regardless of the presence of an air bubble, the supply of ink to the recording head is ensured by ink induction means that is formed upstream of the filter, and the a volume of ink required for printing can be steadily supplied to the recording head.

What is claimed is:

1. An ink-jet recording apparatus comprising:
a recording head for receiving ink supplied via a first ink supply path and for ejecting ink droplets;
a second ink supply path along which ink is transmitted from an ink cartridge to said first ink supply path; and
a filter which is located at a joint area that forms a communication portion situated between said first ink supply path and said second ink supply path,
wherein ink induction paths are formed at said joint area on the side of said second ink supply path in order to use capillary attraction to induce the flow of ink through said filter.

2. An ink-jet recording apparatus according to claim 1, wherein said ink induction paths are constituted by projections that are radially formed at small pitches so as to capture an air bubble.

3. An ink-jet recording apparatus according to claim 1, wherein grooves are formed between said adjacent projections in order to supply ink to said filter using capillary attraction.

4. An ink-jet recording head according to claim 1, wherein said ink induction paths are extended from an ink inlet for said second ink supply path to an area that does not face said first ink supply path.

5. An ink-jet recording head according to claim 4, wherein said ink induction paths are formed at positions that are farthest from said first ink supply path.

6. An ink-jet recording head according to claim 4, wherein said ink induction paths are formed as grooves.

7. An ink-jet recording head according to claim 4, wherein said ink induction paths are formed as ribs.

8. An ink-jet recording head according to claim 4, wherein said ink induction paths are integrally formed with said joint area.

9. An ink-jet recording head according to claim 4, wherein said ink induction paths are formed by mounting a groove formation member in said joint area.

10. An ink-jet recording head according to claim 4, wherein said ink induction paths are formed by mounting a rib formation member in said joint area.

11. An ink-jet recording head according to claim 4, wherein said ink induction paths are formed so as to be coaxial with said second ink supply path.

12. An ink-jet recording head according to claim 4, wherein said ink induction paths are formed in a holder that is to be mounted in said joint area, by using a rod-shaped member that is positioned coaxially with said second ink supply path.

13. An ink-jet recording head according to claim 4, wherein said ink induction paths are formed of a layer that has a greater wettability to ink than has the other area.
